(19) United States
(12) Patent Application Publication
(10) Pub. No.: US 2025/0000152 A1
(43) Pub. Date: Jan. 2, 2025

(54) AEROSOL GENERATING DEVICE WITH SEALED INTERNAL AIRFLOW CHANNEL

(71) Applicant: Philip Morris Products S.A., Neuchatel (CH)

(72) Inventors: Cheng PENG; Jun Wei YIM, Colombier (CH); Yuxiong WANG, Huizhou (CN)

(73) Assignee: Philip Morris Products S.A., Neuchatel (CH)

(21) Appl. No.: 18/700,958

(22) PCT Filed: Oct. 22, 2021
(86) PCT No.: PCT/CN2021/125769

§ 371 Date: Apr. 12, 2024

(51) Int. Cl. A24F 40/48; A24F 40/20; A24F 40/46; F16J 15/06; H05B 3/42

(52) U.S. Cl. CPC A24F 40/48; A24F 40/20; A24F 40/46; F16J 15/06; H05B 3/42

(57) ABSTRACT

An aerosol-generating device is provided, including: an external housing; a tubular heater; top and bottom heater casings, the heater being enclosed within the top and bottom heater casings; an internal airflow channel through the device extending from an air inlet in the external housing to an air outlet in the external housing, the channel passing through the top and bottom casings and the heater; a first sealing element between the external housing and the bottom casing; a second sealing element between the external housing and the top casing; a third sealing element between the bottom and the top casings; a heater holder positioned between the heater and the bottom casing, the channel passing through the heater holder; and a fourth sealing element positioned between the heater holder and the bottom casing, the heater being press fit directly to the top casing.

The present disclosure relates to an aerosol-generating device comprising an airflow channel through the device and to an arrangement for sealing the airflow channel to prevent ingress of liquids or particulates into an interior of the device that contains electrical components.

Aerosol generating devices which heat an aerosol-forming substrate to produce an aerosol without burning the aerosol-forming substrate are known in the art. The aerosol-forming substrate is typically provided within an aerosol-generating article, together with other components such as filters. The aerosol-generating article may have a rod shape for insertion of the aerosol-generating article into a heating chamber of the aerosol-generating device. A heating element is typically arranged in or around the heating chamber for heating the aerosol-forming substrate once the aerosol-generating article is inserted into the heating chamber of the aerosol-generating device.

The heating chamber may be arranged within a housing of the aerosol-generating device and form part of an airflow channel through the aerosol-generating device. It is desirable to prevent aerosol, as well as other liquids or particles, from passing out of the airflow channel and into other parts of the aerosol-generating device, which may cause damage to the electronics of the device.

It would be desirable to provide an arrangement for sealing an airflow channel that provides a robust and reliable sealing and that is simple to manufacture.

According to an example of the present disclosure, there is provided an aerosol-generating device comprising:
an external housing;
a tubular heater;
a top heater casing and a bottom heater casing, the tubular heater being enclosed within the top heater casing and the bottom heater casing;
an internal airflow channel through the device extending from an air inlet in the external housing to an air outlet in the external housing, wherein the internal airflow channel passes through the top heater casing, the bottom heater casing and the heater;
a first sealing element between the external housing and the bottom heater casing;
a second sealing element between the external housing and the top heater casing; and
a third sealing element between the bottom heater casing and the top heater casing.

This arrangement provides a sealed airflow channel in a manner that is simple to manufacture, using relatively few components. The sealing of the heater within the top heater casing and a bottom heater casing, and the sealing of the top heater casing and a bottom heater casing with the external housing, effectively isolates the generated vapour and aerosol from internal components of the device and prevents ingress of liquids or particles from the airflow channel entering the interior space of the device. This improves the longevity and reliability of the device. This arrangement also effectively prevents particles from inside the device from entering the airflow channel and contaminating the generated aerosol.

One or more of the sealing elements may comprise an elastomeric polymer, such as silicone.

The device may comprise a heater holder positioned between the heater and the bottom heater casing, the airflow channel passing through the heater holder, and a fourth sealing element positioned between the heater holder and the bottom heater casing or the top heater casing. A heater holder may be advantageous to secure the heater during device assembly and use. The heater holder also may also separate and shield one or more of the sealing elements from the elevated temperatures at the heater.

Advantageously, the heater is spaced from the sealing elements by at least 4 mm, and preferably by at least 5 mm. Advantageously, the sealing elements are each shielded from the heater by at least one intermediate component, such as the heater holder. Spacing the sealing elements apart from the heater may reduce heat losses through the sealing element, thereby improving heating efficiency.

Minimising the number of components used minimises the number of seals required. However, it is not complex to form the airflow channel and external housing from a single component. Advantageously, the airflow channel is defined only by the external housing, the bottom heater casing, the heater holder, the heater, the top heater casing and the sealing elements. This provides a good balance between minimising components and allowing for a simple assembly process. Making the device out of a small number of pieces has the additional advantage that exchange of those pieces is possible, for example for customization of the device or for maintenance or refurbishment.

The fourth sealing element may be provided between the heater holder and the bottom heater casing. The heater may press fit directly to the top heater casing. The heater holder may be press fit directly to the heater. Press fitting the heater to the surrounding components without using elastomer sealing elements in contact with or close to the heater, means the problem of seal degradation and the formation of undesirable compounds in the aerosol when the sealing elements get too hot can be avoided.

One or more of the sealing elements may comprise an O-ring. Each of the sealing elements may comprise an O-ring.

The external housing may comprise a device top casing and a device bottom casing. The device top casing may be fixed to the device bottom casing. The device top casing may be fixed to the device bottom casing using a mechanical interface, such as a snap fitting or push fitting. The device top casing may be fixed to the device bottom casing using an adhesive or by welding.

Advantageously, the bottom heater casing is fixed to the top heater casing. The bottom heater casing may be fixed to the top heater casing by one or more screw fastenings. The third sealing element may be compressed between the bottom heater casing and the top heater casing.

The heater may comprise one or more heating elements and a thermal insulator positioned around heating element or heating elements.

The electric heating element or elements may be arranged around or circumscribe an external surface of a heating chamber forming part of the airflow channel. The electric heating element or elements may be arranged around or circumscribe an internal surface of the heating chamber. The electric heating element or elements may be part of, or integral to, the heating chamber.

The electric heating element or elements may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal™, Kanthal™ and other iron-chromium-aluminium alloys, and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The one or more heating elements may be formed using a metal or metal alloy having a defined relationship between temperature and resistivity. Heating elements formed in this manner may be used to both heat and monitor the temperature of the heating element during operation.

The heating element may be deposited in or on a rigid carrier material or substrate. The heating element may be deposited in or on a flexible carrier material or substrate. The heating element may be formed as a track on a suitable insulating material, such as ceramic or glass or polyimide film. The heating element may be sandwiched between two insulating materials.

The heater assembly may comprise a flexible heating element arranged around or circumscribing an external surface of the heating chamber. The flexible heating element may have a length substantially equal to the length of an aerosol-forming substrate provided in the aerosol-generating article. The heating chamber may be longer than the heating element.

The thermal insulator may comprise an aerogel. The thermal insulator may comprise a heat resistant tape. The heater may comprise a heater housing holding the thermal insulator.

The aerosol-generating device may comprise electrical connection pins connected to the heater, the electrical connection pins passing through openings in the bottom casing. The opening in the bottom casing may be sealed with an adhesive to prevent ingress of liquids or particulates from the airflow channel.

The aerosol-generating device may comprise control circuitry and a power supply within the external housing. The control circuitry may be electrically connected to the power supply and to the heater.

The power supply may be any suitable power supply, for example a DC voltage source. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate or a Lithium-Polymer battery.

The control circuitry may be configured to control a supply of electrical power to the heater assembly. The control circuitry may comprise a microprocessor. The microprocessor may be a programmable microprocessor, a microcontroller, or an application specific integrated chip (ASIC) or other electronic circuitry capable of providing control. The control circuitry may comprise further electronic components. For example, in some embodiments, the control circuitry may comprise any of: sensors, switches, display elements. Power may be supplied to the heater assembly continuously following activation of the device or may be supplied intermittently, such as on a puff-by-puff basis. The power may be supplied to the heater assembly in the form of pulses of electrical current, for example, by means of pulse width modulation (PWM).

The aerosol-generating device is preferably a handheld aerosol-generating device that is comfortable for a user to hold between the fingers of a single hand.

The external housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The aerosol-generating device may be used in conjunction with disposable aerosol-generating articles comprising an aerosol-forming substrate. An aerosol-generating system may comprise an aerosol-generating device as disclosed herein and an aerosol-generating article configured for use with the aerosol-generating device. The aerosol-generating device may be configured to receive an aerosol generating article containing an aerosol-forming substrate through the air outlet and into heater.

The terms “distal”, “upstream” “proximal” and “downstream” are used to describe the relative positions of components, or portions of components, of an aerosol-generating device or an aerosol generating article. Aerosol generating articles and devices according to the present disclosure may have a proximal end through which, in use, an aerosol exits the article or device for delivery to a user, and may have an opposing distal end. The proximal end of the aerosol generating article and device may also be referred to as the mouth end. In use, a user draws on the proximal end of the aerosol generating article in order to inhale an aerosol generated by the aerosol generating article or device. The terms upstream and downstream are relative to the direction of aerosol movement through the aerosol generating article or aerosol-generating device when a user draws on the proximal end of the aerosol-generating article. The proximal end of the aerosol-generating article is downstream of the distal end of the aerosol-generating article. The proximal end of the aerosol-generating article may also be referred to as the downstream end of the aerosol-generating article and the distal end of the aerosol-generating article may also be referred to as the upstream end of the aerosol-generating article.

According to an example of the present disclosure, there is provided an aerosol-generating system comprising an aerosol-generating device according to the example described above. The aerosol-generating system may comprise an aerosol-generating article comprising an aerosol-forming substrate.

According to an example of the present disclosure, there is provided an aerosol-generating system comprising: an aerosol-generating device according to the example described above; and an aerosol-generating article comprising an aerosol-forming substrate.

As used herein, the term “aerosol-generating article” refers to an article comprising an aerosol-forming substrate that, when heated in an aerosol-generating device, releases volatile compounds that can form an aerosol. An aerosol-generating article is separate from and configured for combination with an aerosol-generating device for heating the aerosol-generating article.

The aerosol-generating article may be substantially cylindrical in shape. The aerosol-generating article may be substantially elongate. The aerosol-forming substrate may be substantially cylindrical in shape. The aerosol-forming substrate may be substantially elongate.

The aerosol-generating article may have a total length between approximately 30 mm and approximately 100 mm. The aerosol-generating article may have an external diameter between approximately 5 mm and approximately 12 mm. The aerosol-forming substrate may have a length of between approximately 10 mm and approximately 18 mm. Further, the diameter of the aerosol-forming substrate may be between approximately 5 mm and approximately 12 mm. The aerosol-generating article may comprise a filter plug. The filter plug may be located at the downstream end of the aerosol-generating article. The filter plug may be a cellulose acetate filter plug. The filter plug is approximately 7 mm in length in one embodiment, but may have a length of between approximately 5 mm to approximately 12 mm.

In one embodiment, the aerosol-generating article may have a total length of approximately 45 mm. The aerosol-generating article may have an external diameter of approximately 7.3 mm but may have an external diameter of between approximately 7.0 mm and approximately 7.4 mm. Further, the aerosol-forming substrate may have a length of approximately 12 mm. Alternatively, the aerosol-forming substrate may have a length of approximately 16 mm. The aerosol-generating article may comprise an outer paper wrapper. Further, the aerosol-generating article may comprise a separation between the aerosol-forming substrate and the filter plug. The separation may be approximately 21 mm or approximately 26 mm, but may be in the range of approximately 5 mm to approximately 28 mm. The separation may be provided by a hollow tube. The hollow tube may be a made from cardboard or cellulose acetate.

The aerosol-forming substrate may be a solid aerosol-forming substrate. Alternatively, the aerosol-forming substrate may comprise both solid and liquid components. The aerosol-forming substrate may comprise a tobacco-containing material containing volatile tobacco flavour compounds which are released from the substrate upon heating. Alternatively, the aerosol-forming substrate may comprise a non-tobacco material. The aerosol-forming substrate may further comprise an aerosol former. Examples of suitable aerosol formers are glycerine and propylene glycol.

If the aerosol-forming substrate is a solid aerosol-forming substrate, the solid aerosol-forming substrate may comprise, for example, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco and expanded tobacco. The solid aerosol-forming substrate may be in loose form, or may be provided in a suitable container or cartridge. Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

As used herein, homogenised tobacco refers to material formed by agglomerating particulate tobacco. Homogenised tobacco may be in the form of a sheet. Homogenised tobacco material may have an aerosol-former content of greater than 5% on a dry weight basis. Homogenised tobacco material may alternatively have an aerosol former content of between 5% and 30% by weight on a dry weight basis. Sheets of homogenised tobacco material may be formed by agglomerating particulate tobacco obtained by grinding or otherwise comminuting one or both of tobacco leaf lamina and tobacco leaf stems.

Alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof.

In a particularly preferred embodiment, the aerosol-forming substrate comprises a gathered crimpled sheet of homogenised tobacco material. As used herein, the term ‘crimped sheet’ denotes a sheet having a plurality of substantially parallel ridges or corrugations. Preferably, when the aerosol-generating article has been assembled, the substantially parallel ridges or corrugations extend along or parallel to the longitudinal axis of the aerosol-generating article. This advantageously facilitates gathering of the crimped sheet of homogenised tobacco material to form the aerosol-forming substrate. However, it will be appreciated that crimped sheets of homogenised tobacco material for inclusion in the aerosol-generating article may alternatively or in addition have a plurality of substantially parallel ridges or corrugations that are disposed at an acute or obtuse angle to the longitudinal axis of the aerosol-generating article when the aerosol-generating article has been assembled. In certain embodiments, the aerosol-forming substrate may comprise a gathered sheet of homogenised tobacco material that is substantially evenly textured over substantially its entire surface. For example, the aerosol-forming substrate may comprise a gathered crimped sheet of homogenised tobacco material comprising a plurality of substantially parallel ridges or corrugations that are substantially evenly spaced-apart across the width of the sheet.

Optionally, the solid aerosol-forming substrate may be provided on or embedded in a thermally stable carrier. The carrier may take the form of powder, granules, pellets, shreds, spaghettis, strips or sheets. Alternatively, the carrier may be a tubular carrier having a thin layer of the solid substrate deposited on its inner surface, or on its outer surface, or on both its inner and outer surfaces. Such a tubular carrier may be formed of, for example, a paper, or paper like material, a non-woven carbon fibre mat, a low mass open mesh metallic screen, or a perforated metallic foil or any other thermally stable polymer matrix.

The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

Although reference is made to solid aerosol-forming substrates above, it will be clear to one of ordinary skill in the art that other forms of aerosol-forming substrate may be used with other embodiments. For example, the aerosol-forming substrate may be a liquid aerosol-forming substrate. If a liquid aerosol-forming substrate is provided, the aerosol-generating device preferably comprises means for retaining the liquid. For example, the liquid aerosol-forming substrate may be retained in a container or a liquid storage portion. Alternatively or in addition, the liquid aerosol-forming substrate may be absorbed into a porous carrier material. The porous carrier material may be made from any suitable absorbent plug or body, for example, a foamed metal or plastics material, polypropylene, terylene, nylon fibres or ceramic. The liquid aerosol-forming substrate may be retained in the porous carrier material prior to use of the aerosol-generating device or alternatively, the liquid aerosol-forming substrate material may be released into the porous carrier material during, or immediately prior to use. For example, the liquid aerosol-forming substrate may be provided in a capsule. The shell of the capsule preferably melts upon heating and releases the liquid aerosol-forming substrate into the porous carrier material. The capsule may optionally contain a solid in combination with the liquid.

Alternatively, the carrier may be a non-woven fabric or fibre bundle into which tobacco components have been incorporated. The non-woven fabric or fibre bundle may comprise, for example, carbon fibres, natural cellulose fibres, or cellulose derivative fibres.

Examples in accordance with the aspects of the disclosure will be now be described with reference to the accompany drawings, in which:

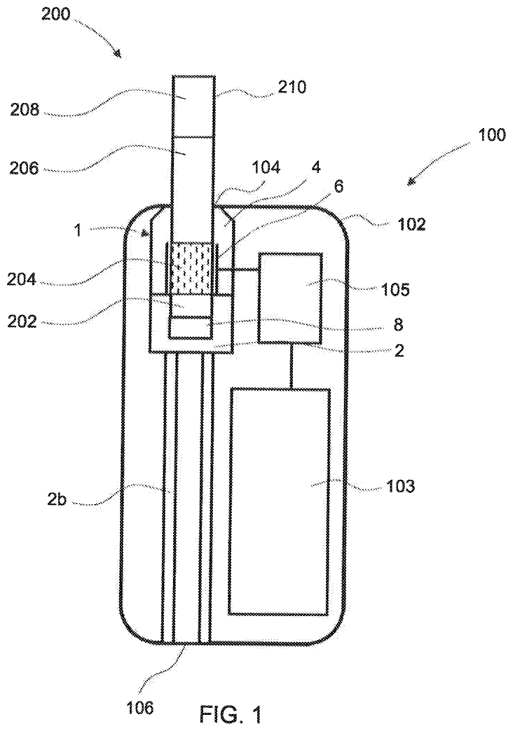

FIG. 1 is a schematic cross-sectional view showing the interior of an aerosol-generating device 100 and an aerosol-generating article 200 received within the aerosol-generating device 100;

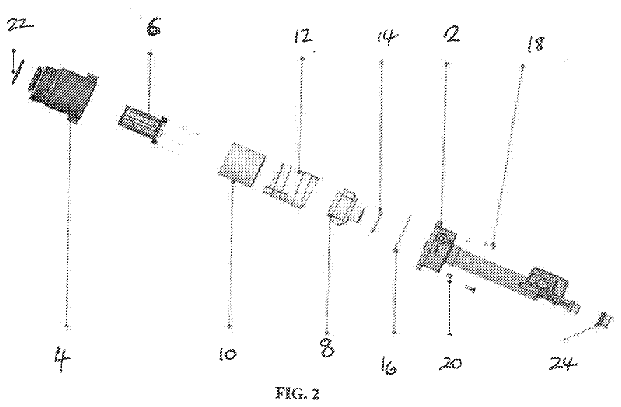

FIG. 2 is an exploded view of a heater module for use in a system as shown in FIG. 1; and

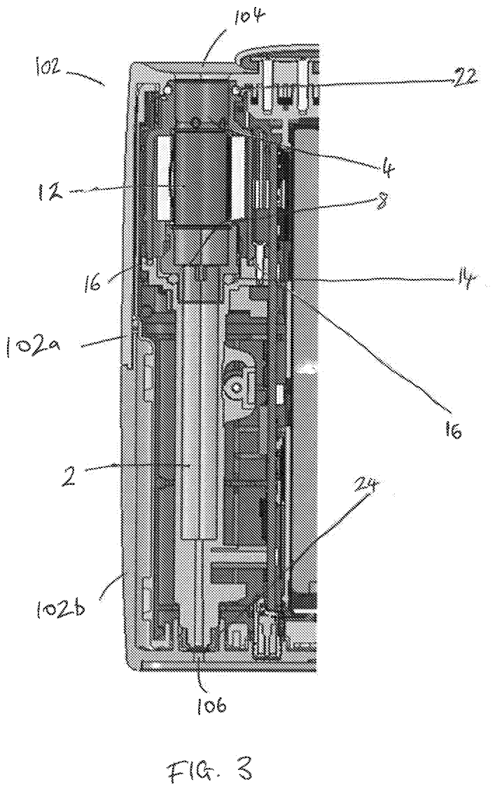

FIG. 3 is a partial cross sectional view of an aerosol generating device of the type shown in FIG. 1, including the heater module shown in FIG. 2.

FIG. 1 is a schematic cross-sectional view showing the interior of an aerosol-generating device 100 and an aerosol-generating article 200 received within the aerosol-generating device 100. Together, the aerosol-generating device 100 and aerosol-generating article 200 form an aerosol-generating system. In FIG. 1, the aerosol-generating device 100 is shown in a simplified manner. In particular, the elements of the aerosol-generating device 100 are not drawn to scale. Furthermore, elements that are not relevant for the understanding of the aerosol-generating device 100 have been omitted.

The aerosol-generating device 100 comprises a housing 102 containing a tubular heater 6, a power supply 103 and control circuitry 105. In FIG. 1, the bottom heater casing part 2, heater mount 8 and top heater casing part 4 are shown. The power supply 103 is a battery and, in this example, it is a rechargeable lithium ion battery. The control circuitry 105 is connected to both the power supply 103 and the heating element and controls the supply of electrical energy from the power supply 103 to the heater to regulate the temperature of the heater.

The housing 102 comprises an opening 104 at a proximal or mouth end of the aerosol-generating device 100 through which an aerosol-generating article 200 is received. The opening 104 is connected to the opening 12 in the heater module 1, through which aerosol exits the heater module 1. However, it will be appreciated that aerosol largely exits the heater module 1 and the aerosol-generating device 100 via the aerosol-generating article 200. The housing 102 further comprises an air inlet 106 at a distal end of the aerosol-generating device 100. The air inlet 106 is connected to the air inlet arranged at a distal end of the first tubular section 2b of the bottom casing part 2. The first tubular section 2b delivers air from the air inlet 106 to the aerosol-generating article.

The aerosol-generating article 200 comprises an end plug 202, an aerosol-forming substrate 204, a hollow tube 206, and a mouthpiece filter 208. Each of the aforementioned components of the aerosol-generating article 100 is a substantially cylindrical element, each having substantially the same diameter. The components are arranged sequentially in abutting coaxial alignment and are circumscribed by an outer paper wrapper 210 to form a cylindrical rod. The aerosol-forming substrate 204 is a tobacco rod or plug comprising a gathered sheet of crimped homogenised tobacco material circumscribed by a wrapper (not shown). The crimped sheet of homogenised tobacco material comprises glycerine as an aerosol-former. The end plug 202 and mouthpiece filter 208 are formed from cellulose acetate fibres.

A distal end of the aerosol-generating article 200 is inserted into the aerosol-generating device 100 via the opening 104 in the housing 102 and pushed into the aerosol-generating device 100 until it engages a stop (not shown in FIG. 1) arranged on the heater mount 8, at which point it is fully inserted. The stop helps to correctly locate the aerosol-forming substrate 204 within the heater so that the heater can heat the aerosol-forming substrate 204 to form an aerosol.

The aerosol-generating device 100 may further comprise: a sensor (not shown) for detecting the presence of the aerosol-generating article 200; a user interface (not shown) such as a button for activating the heater; and a display or indicator (not shown) for presenting information to a user, for example, remaining battery power, heating status and error messages.

In use, a user inserts an aerosol-generating article 200 into the aerosol-generating device 100, as shown in FIG. 1. The user then starts a heating cycle by activating the aerosol-generating device 100, for example, by pressing a switch to turn the device on. In response, the control circuitry 105 controls a supply of electrical power from the power supply 103 to the heater to heat the heater. During a heating cycle, the heater is heated to a predefined temperature, or to a range of predefined temperatures according to a temperature profile. A heating cycle may last for around 6 minutes. The heat from the heater 6 is transferred to the aerosol-forming substrate 204 which releases volatile compounds from the aerosol-forming substrate 204. The volatile compounds form an aerosol within an aerosolisation chamber formed by the hollow tube 206. During a heating cycle, the user places the mouthpiece filter 208 of the aerosol-generating article 200 between the lips of their mouth and takes a puff or inhales on the mouthpiece filter 208. The generated aerosol is then drawn through the mouthpiece filter 208 into the mouth of the user.

FIG. 2 is an exploded view of a heater module for use in a system as shown in FIG. 1. The heater module comprises outer casing comprising of a top heater casing part 4 and a bottom heater casing part 2. Within the outer casing is a heater 6, which comprises heater tracks on a flexible heater substrate. Aerogel insulation 10 and high temperature resistant tape 12 surround the heater. The heater is mounted on heater holder 8. The heater module also includes sealing elements 14, 16, 22 and 24. The top heater casing part is fixed to the bottom heater casing part using screws 18. Electrical pins from the heater 6 extend out through openings in the bottom casing part 2. Those openings are sealed with glue 20.

An advantage of the heater module is that, while the top heater casing part includes and protects inside the heater 6, the bottom heater casing part provides an elongated channel along which an air flow path is created whenever the consumer draws a puff on the consumable after final assembly in a device (see FIG. 1). Another advantage of the proposed solution is that the heater module can be used as a standalone module to be plug into any kind of different device design, the only constraint being the minimum length of the device which basically corresponds to the length of the heater module itself.

FIG. 3 is a partial cross sectional view of an aerosol generating device of the type shown in FIG. 1, including the heater module shown in FIG. 2. The heater module is positioned inside external housing 102. The external housing 102 has a top housing part 102a and a bottom housing part 102b that a snap fit together. An airflow channel is formed through the device. The airflow channel starts at air inlet 106 formed in the bottom housing part 102b. It then passes through bottom heater casing part 2, through heater holder 8, through the tubular heater (the surrounding tape 12 is shown), through top heater casing part 4 and then through air outlet 104 formed in the top housing part 102a.

The airflow channel is sealed at the joins between the components defining the airflow channel. A first sealing element 24 is between the bottom external housing part and the bottom heater casing. The first sealing element 24 is formed from silicone and is sleeved around a bottom part of the bottom heater casing part 2. The first sealing element 24 is compressed between the bottom heater casing 2 and the bottom housing part 102b.

A second sealing element 22 is between the top external housing part and the top heater casing part 4. The second sealing element is a silicone O-ring. The second sealing element 22 is compressed between the top heater casing part 4 and the top housing part 102a.

A third sealing element 16 is provided between the top heater casing part 4 and the bottom heater casing part 2. The third sealing element is a silicone O-ring. The third sealing element is compressed between the top heater casing part 4 and the bottom heater casing part 2, which are held together using screws, as described.

A fourth sealing element 14 is provided between the bottom heater casing part 2 and the heater holder 8. The fourth sealing element is a silicone O-ring. The fourth sealing element is compressed between the heater holder 8 and the bottom heater casing part 2.

Each of the sealing elements is configured to provide a seal that prevents ingress of liquids and particles to the IP67 standard, according to the IP Code, or Ingress Protection Code is defined in IEC standard 60529.

The heater is held in place between the heater holder 8 and the top heater casing part 4. The heater is press fit to both the heater holder 8 and the top heater casing part 4. There are no polymer seals in contact with the heater. The closest sealing elements, third sealing element 16 and fourth sealing element 14 are each at least 4 mm from the closest part of the heater. In this way no polymer seals are subject to potentially degrading temperatures during use of the device.

1.-16. (canceled)

17. An aerosol-generating device, comprising:
an external housing;
a tubular heater;
a top heater casing and a bottom heater casing, the tubular heater being enclosed within the top heater casing and the bottom heater casing;
an internal airflow channel through the aerosol-generating device extending from an air inlet in the external housing to an air outlet in the external housing, wherein the internal airflow channel passes through the top heater casing, the bottom heater casing, and the tubular heater;
a first sealing element between the external housing and the bottom heater casing;
a second sealing element between the external housing and the top heater casing;
a third sealing element between the bottom heater casing and the top heater casing;
a heater holder positioned between the tubular heater and the bottom heater casing, the internal airflow channel passing through the heater holder; and
a fourth sealing element positioned between the heater holder and the bottom heater casing,
wherein the tubular heater is press fit directly to the top heater casing.

18. The aerosol-generating device according to claim 17, wherein the internal airflow channel is defined only by the external housing, the bottom heater casing, the heater holder, the tubular heater, the top heater casing, and the sealing elements.

19. The aerosol-generating device according to claim 17, wherein the heater holder is press fit directly to the tubular heater.

20. The aerosol-generating device according to claim 17, wherein one or more of the sealing elements comprises an O-ring.

21. The aerosol-generating device according to claim 17, wherein one or more of the sealing elements comprises an elastomeric polymer, such as silicone.

22. The aerosol-generating device according to claim 17, wherein one or more of the sealing elements comprises silicone.

23. The aerosol-generating device according to claim 17, wherein the tubular heater is spaced from the sealing elements by at least 4 mm.

24. The aerosol-generating device according to claim 17, wherein the tubular heater is spaced from the sealing elements by at least 5 mm.

25. The aerosol-generating device according to claim 17, wherein the sealing elements are each shielded from the tubular heater by at least one intermediate component.

26. The aerosol-generating device according to claim 17, wherein the external housing comprises a device top casing and a device bottom casing, the device top casing being fixed to the device bottom casing.

27. The aerosol-generating device according to claim 17, wherein the bottom heater casing is fixed to the top heater casing.

28. The aerosol-generating device according to claim 27, wherein the bottom heater casing is fixed to the top heater casing by one or more screw fastenings.

29. The aerosol-generating device according to claim 17, wherein the tubular heater comprises a heating element and a thermal insulator positioned around the heating element.

30. The aerosol-generating device according to claim 17, further comprising electrical connection pins connected to the tubular heater, the electrical connection pins passing through openings in the bottom casing, the openings in the bottom casing being sealed with an adhesive.

31. The aerosol-generating device according to claim 17, further comprising control circuitry and a power supply within the external housing, the control circuitry being electrically connected to the power supply and to the tubular heater.

32. The aerosol-generating device according to claim 17, wherein the aerosol-generating device is configured to receive an aerosol generating article containing an aerosol-forming substrate through the air outlet and into the tubular heater.
